(19) United States
(12) Patent Application Publication
(10) Pub. No.: US 2006/0129862 A1
(43) Pub. Date: Jun. 15, 2006

(54) Power saving device for network controller of computer

(75) Inventors: Chun-Hu Liu, Tao Yuan Shien (TW); Kai-Chun Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/091,117

(22) Filed: Mar. 28, 2005

(30) Foreign Application Priority Data
Dec. 14, 2004 (TW) 93138710

(51) Int. Cl. G06F 1/26

(52) U.S. Cl. 713/324

(57) ABSTRACT

The computer comprises a power supply for supplying power. The power saving device for network controller of computer comprises a network controller, a switch connecting between the power supply and the network controller, a control circuit connecting the power supply and the switch and a network connector. The network comprises a network pin and a power saving pin. The network pin is electrically connected the network controller. The power saving pin is electrically connected the control circuit. When access to the Internet is not required, the computer cuts off power to the network controller via the power saving pin to reduce power consumption.

### BACKGROUND

The invention relates to a power saving device for network controller of computer, and in particular to an independent power saving device for network controller.

Notebook computer offers the advantages of portability and convenience. If a user cannot find a socket to provide power for the portable personal computer, however, battery lifespan becomes a critical issue. Thus, reduced power consumption is desirable.

Referring to FIG. 1, a conventional notebook computer comprises a power supply 30, network controller 33 and a control circuit 35. The power supply 30 is electrically connected to the network controller 33 and the control circuit 35. The network controller 33 is electrically connected to the control circuit 35. When a network cable is connected to the notebook computer, the Internet can be accessed via the network controller 33 powered by the power supply 30. When the network cable is removed from the notebook computer, however, the power supply 30 still provides power to the network controller 33. That is, the power supply 30 of the conventional notebook computer continues supplying power to the network controller 33 even if the notebook computer is not connected to the Internet. Therefore, the power for the whole system is wasted.

### SUMMARY

A network cable provides access to the Internet for a computer. The computer comprises a power supply for supplying power. An embodiment of the invention provides a power saving device for network controller of computer comprising a network controller, a switch, a control circuit, and a network connector. The switch is electrically connected to the power supply and the network controller. The control circuit is electrically connected to the switch and the power supply. The network connector comprises a plurality of network pins and a power saving pin. The network pins are electrically connected to the network controller. The power saving pin is electrically connected to the network controller. When the network cable is electrically connected to the network connector, the power supply provides electricity to the network controller and when the network cable is not electrically connected to the network connector, the power supply does not provide electricity to the network controller.

### BRIEF DESCRIPTION OF THE DRAWINGS

The invention can be more fully understood by reading the subsequent detailed description in conjunction with the examples and references made to the accompanying drawings, wherein:

FIG. 1 is block diagram of a conventional notebook computer;

FIG. 2 shows an embodiment is block diagram of a notebook computer;

FIG. 3 depicts the relationship between logic potential and time;

FIG. 4 depicts the relationship between logic potential and time.

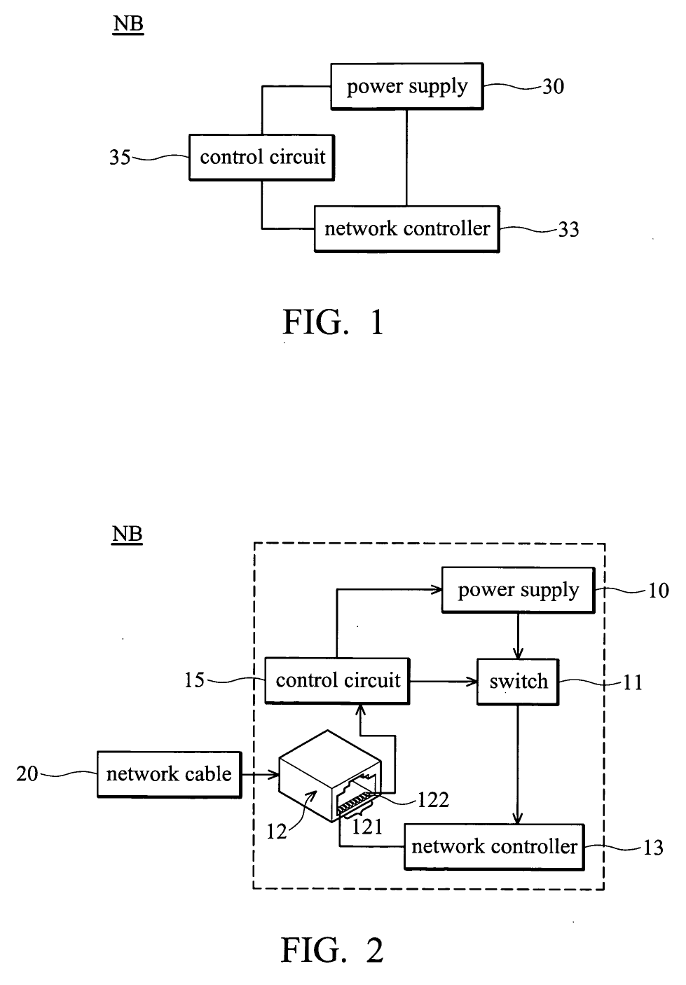

### DETAILED DESCRIPTION

Referring to FIG. 2, the invention provides a power saving device for network controller of computer. The notebook computer comprises a power supply 10 for providing power to the portable personal computer. The present power saving device comprises a switch 11, a control circuit 15, a network connector 12 and a network controller 13. The switch 11, connected to the power supply 10 and the network controller 13 controls the power supply 10 to provide power for the network controller 13. In this embodiment, the switch is preferred an electric control switch, MOSFET. The control circuit 15, electrically connected to the power supply 10 and the network connector 12 is a southbridge controller. The network connector 12 has nine pins, comprising a plurality of network pins 121 and a power saving pin 122. The network pins 121 comprise the first to eighth pins for transmitting a network signal. The power saving pin 122 comprises the ninth pin.

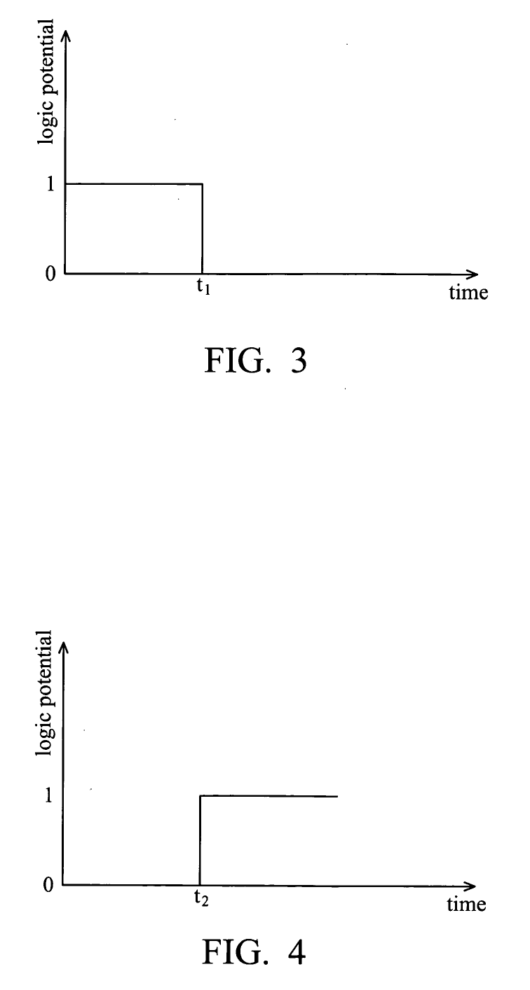

Referring to FIGS. 2 and 3, a network cable 20 is connected to the network connector 12 of the notebook computer to access the Internet. The power saving device forms a low logic potential between the power saving pin 122 and the control circuit 15 at t₁ of FIG. 3. When the control circuit 15 receives the low logic potential, the switch turns on so that the power supply 10 provides power to the network controller 13.

Referring to FIGS. 2 and 4, when not using the Internet, the network cable 20 is removed from the network connector 12 of the notebook computer. The power saving device forms a high logic potential between the power saving pin 122 and the control circuit 15 at t₂ of the FIG. 4. When the control circuit 15 receives the high logic potential, the switch turns off so that the power supply 10 cuts off power to the network controller 13.

Notebook computer barreries have a limited supply of power. The invention extends the battery lifespan by reducing power consumption. The invention provides a power saving device for network controller of computer. When no network cable is present, power to the network controller is cut off via the power saving pin to reduce power consumption.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power saving device for network controller of computer, wherein a network cable provides Internet access for the computer and the computer comprises a power supply providing power thereto, comprising:
a network controller;
a switch electrically connected to the power supply and the network controller;
a control circuit electrically connected to the switch and the power supply; and
a network connector comprising:
a plurality of network pins electrically connected to the network controller; and
a power saving pin electrically connected to the network controller;
wherein when the network cable is electrically connected to the network connector, the power supply provides power to the network controller and when the network cable is not electrically connected to the network connector, the power supply does not provide power to the network controller.

2. The power saving device for network controller of computer as claimed in claim 1, wherein the switch is an electric control switch.

3. The power saving device for network controller of computer as claimed in claim 2, wherein the switch is a MOSFET.

4. The power saving device for network controller of computer as claimed in claim 1, wherein the control circuit is a southbridge controller.

5. The power saving device for network controller of computer as claimed in claim 1, further comprising a low logic potential between the power saving pin and the control circuit wherein when the network cable is electrically connected to the network connector, the control circuit directs the power supply to provide electricity to the network controller via the low logic potential.

6. The power saving device for network controller of computer as claimed in claim 1, further comprising a high logic potential between the power saving pin and the control circuit wherein when the network cable is not electrically connected to the network connector, the control circuit directs the power supply to cut power to the network controller via the high logic potential.

7. A power saving device for network controller of computer, wherein a network cable provides Internet access for the notebook computer and the notebook computer comprises a power supply for supplying power, comprising:
a network controller;
a switch electrically connected to the power supply and the network controller;
a control circuit electrically connected to the switch and the power supply;
a network connector comprising:
a plurality of network pins electrically connected to the network controller; and
a power saving pin electrically connected to the network controller;
a low logic potential between the power saving pin and the control circuit; and
a high logic potential between the power saving pin and the control circuit;
wherein when the network cable is electrically connected to the network connector, the control circuit directs the power supply to supply power to the network controller via the low logic potential and when the network cable is not electrically connected to the network connector, the control circuit directs the power supply to cut off power to the network controller via the high logic potential.
